(19) United States
(12) Patent Application Publication
(10) Pub. No.: US 2019/0036114 A1
(43) Pub. Date: Jan. 31, 2019

(54) POSITIVE ELECTRODE ACTIVE MATERIAL FOR MULTIVALENT-ION SECONDARY BATTERY, POSITIVE ELECTRODE FOR MULTIVALENT-ION SECONDARY BATTERY, MULTIVALENT-ION SECONDARY BATTERY, BATTERY PACK, ELECTRIC VEHICLE, POWER STORAGE SYSTEM, POWER TOOL, AND ELECTRONIC DEVICE

(71) Applicant: MURATA MANUFACTURING CO., LTD., Kyoto (JP)

(72) Inventors: Ryuhei MATSUMOTO, Kyoto (JP); Daisuke MORI, Kyoto (JP); Yuri NAKAYAMA, Kyoto (JP); Hideki KAWASAKI, Kyoto (JP)

(21) Appl. No.: 16/146,289

(22) Filed: Sep. 28, 2018

Related U.S. Application Data
(63) Continuation of application No. PCT/JP2017/001659, filed on Jan. 19, 2017.

(30) Foreign Application Priority Data
Mar. 30, 2016 (JP) 2016-069667

(51) Int. Cl. H01M 4/36; H01M 4/38; H01M 4/62; H01M 10/0569; H01M 10/054

(52) U.S. Cl. CPC H01M 4/366; H01M 4/38; H01M 2004/028; H01M 10/0569; H01M 10/054; H01M 4/624

(57) ABSTRACT

A positive electrode active material for multivalent-ion secondary battery is provided. The positive electrode active material includes sulfur, and the sulfur is coated with a polyethylene dioxythiophene-based conductive polymer doped with a sulfonic acid-based compound.

### CROSS REFERENCE TO RELATED APPLICATIONS

The present application is a continuation of PCT patent application no. PCT/JP2017/001659, filed on Jan. 19, 2017, which claims priority to Japanese patent application no. JP2016-069667 filed on Mar. 30, 2016, the entire contents of which are being incorporated herein by reference.

### BACKGROUND

The present technology generally relates to a positive electrode active material for multivalent-ion secondary battery, a positive electrode for multivalent-ion secondary battery, and a multivalent-ion secondary battery. More particularly, the present technology relates to a positive electrode active material for multivalent-ion secondary battery, a positive electrode for multivalent-ion secondary battery, a multivalent-ion secondary battery, a battery pack, an electric vehicle, a power storage system, a power tool, and an electronic device.

In recent years, a multivalent-ion secondary battery is attracting attention from the viewpoints of battery performance, resource reserves of electrode reactants, cost, and safety, and research and development on the multivalent-ion secondary battery have been actively conducted.

A magnesium-ion secondary battery which is an example of the multivalent-ion secondary batteries is expected to be the next-generation secondary battery to replace a lithium ion battery due to the fact that, compared with lithium used in the lithium ion battery which is an example of monovalent-ion secondary batteries, magnesium is more abundant in terms of resource and much more inexpensive, and has a larger amount of electricity per unit volume that can be taken out by a redox reaction, and higher safety when used for a battery.

As the monovalent-ion secondary battery, there is proposed a lithium ion secondary battery using sulfur nanoparticles coated with polyaniline (PANI), polypyrrole (PPY), and poly(3,4-ethylenedioxythiophene) (PEDOT), which are conductive polymers.

### SUMMARY

The present technology generally relates to a positive electrode active material for multivalent-ion secondary battery, a positive electrode for multivalent-ion secondary battery, and a multivalent-ion secondary battery. More particularly, the present technology relates to a positive electrode active material for multivalent-ion secondary battery, a positive electrode for multivalent-ion secondary battery, a multivalent-ion secondary battery, a battery pack, an electric vehicle, a power storage system, a power tool, and an electronic device.

The present technology provides, for example, a positive electrode active material for multivalent-ion secondary battery by which excellent battery characteristics can be achieved, a positive electrode for multivalent-ion secondary battery, a multivalent-ion secondary battery having excellent battery characteristics, a battery pack including the multivalent-ion secondary battery, an electric vehicle, a power storage system, a power tool, and an electronic device.

As a result of extensive research to solve the above-mentioned object, the present inventors have succeeded in dramatically improving battery characteristics by using a polyethylene dioxythiophene-based conductive polymer doped with a sulfonic acid-based compound for the multivalent-ion secondary battery and completed the present technology.

According to an embodiment of the present technology, a positive electrode active material for multivalent-ion secondary battery is provided. The positive electrode active material include sulfur, where the sulfur is coated with a polyethylene dioxythiophene-based conductive polymer doped with a sulfonic acid-based compound.

According to another embodiment of the present technology, a positive electrode for multivalent-ion secondary battery is provided. The positive electrode includes at least a positive electrode active material, where the positive electrode active material contains sulfur, and the sulfur is coated with a polyethylene dioxythiophene-based conductive polymer doped with a sulfonic acid-based compound.

According to another embodiment of the present technology, a positive electrode for multivalent-ion secondary battery is provided. The positive electrode includes at least a sulfur carbon composite including sulfur and a carbon material, where the sulfur carbon composite is coated with a polyethylene dioxythiophene-based conductive polymer doped with a sulfonic acid-based compound.

According to another embodiment of the present technology, a multivalent-ion secondary battery is provided. The multivalent-ion secondary battery includes: the positive electrode for multivalent-ion secondary battery according to the embodiments as described herein; a negative electrode; and an electrolytic solution, where the electrolytic solution includes a solvent including sulfone and a metal salt dissolved in the solvent.

According to another embodiment of the present technology, a multivalent-ion secondary battery is provided. The multivalent-ion secondary battery includes: the positive electrode for multivalent-ion secondary battery according to the embodiments as described herein; a negative electrode; and an electrolytic solution, where the electrolytic solution includes a solvent including sulfone and a metal salt dissolved in the solvent.

The metal salt may include a magnesium salt.

According to another embodiment of the present technology, a battery pack is provided. The battery pack includes: the multivalent-ion secondary battery according to the embodiments as described herein; a controller configured to control a usage state of the multivalent-ion secondary battery; and a switch configured to switch the usage state of the multivalent-ion secondary battery in response to an instruction from the controller.

According to another embodiment of the present technology, an electric vehicle is provided. The electric vehicle includes: the multivalent-ion secondary battery according to the embodiments as described herein; a converter configured to convert electric power supplied from the multivalent-ion secondary battery to driving force; a driver configured to drive in response to the driving force; and a controller configured to control a usage state of the multivalent-ion secondary battery.

According to another embodiment of the present technology, a power storage system is provided. The power storage system includes: the multivalent-ion secondary battery according to the embodiments as described herein; one or more electric devices in which electric power is configured to be supplied from the multivalent-ion secondary battery; and a controller configured to supply of power from the multivalent-ion secondary battery to the electric devices.

According to another embodiment of the present technology, a power tool is provided. The power tool includes the multivalent-ion secondary battery according to the embodiments as described herein and a movable part to which electric power is configured to be supplied from the multivalent-ion secondary battery.

According to another embodiment of the present technology, an electronic device is provided. The electronic device includes the multivalent-ion secondary battery according to the present technology as a power supply source.

According to the present technology, battery characteristics can be improved. It should be understood that the effects described herein are not necessarily limited, and other suitable properties relating to the present technology may be realized and as further described.

### BRIEF DESCRIPTION OF THE FIGURES

FIG. 1 is a view illustrating SEM images (×1,000, ×10,000, ×50,000) of S-PEDOT nanospheres synthesized in Example 1 according to an embodiment of the present technology.

FIG. 2 is a schematic view of a coin battery cell used in Examples according to an embodiment of the present technology.

FIG. 3 is a diagram illustrating comparison results between the initial discharge capacity of an Mg—S battery using S-PEDOT nanospheres as the positive electrode active materials and the initial discharge capacity of an Mg—S battery using untreated sulfur (Bare S) as the positive electrode active material according to an embodiment of the present technology.

FIG. 4 is a diagram illustrating comparison results between the open circuit voltage after 24 hours in an Mg—S battery using S-PEDOT nanospheres as the positive electrode active materials and the open circuit voltage after 24 hours in an Mg—S battery using untreated sulfur (Bare S) as the positive electrode active ma according to an embodiment of the present technology terial.

FIG. 5 is a diagram illustrating comparison results between the initial discharge capacity of an Mg—S battery using a sulfur carbon composite coated with PEDOT-PSS and the initial discharge capacity of an Mg—S battery using a sulfur carbon composite (untreated sulfur) according to an embodiment of the present technology.

FIG. 6 is a block diagram illustrating the configuration of an application example (battery pack) of a multivalent-ion secondary battery according to an embodiment of the present technology.

FIG. 7 is a block diagram illustrating the configuration of an application example (electric vehicle) of a multivalent-ion secondary battery according to an embodiment of the present technology.

FIG. 8 is a block diagram illustrating the configuration of an application example (power storage system) of a multivalent-ion secondary battery according to an embodiment of the present technology.

FIG. 9 is a block diagram illustrating the configuration of an application example (power tool) of a multivalent-ion secondary battery according to an embodiment of the present technology.

### DETAILED DESCRIPTION

The present technology generally relates to a positive electrode active material for multivalent-ion secondary battery, a positive electrode for multivalent-ion secondary battery, and a multivalent-ion secondary battery. More particularly, the present technology relates to a positive electrode active material for multivalent-ion secondary battery, a positive electrode for multivalent-ion secondary battery, a multivalent-ion secondary battery, a battery pack, an electric vehicle, a power storage system, a power tool, and an electronic device.

As described herein, the present disclosure will be described based on examples with reference to the drawings, but the present disclosure is not to be considered limited to the examples, and various numerical values and materials in the examples are considered by way of example.

A positive electrode active material for multivalent-ion secondary battery according to a first embodiment of the present technology is a positive electrode active material for multivalent-ion secondary battery including sulfur, where the sulfur is coated with a polyethylene dioxythiophene-based conductive polymer doped with a sulfonic acid-based compound.

Here, the multivalent-ion secondary battery refers to a battery in which when ionized, a positive ion (also referred to as “cation”) having a valence of 2 or more becomes an electrode reactant (a substance responsible for electrical conduction during charging and discharging), such as magnesium ion (Mg²⁺), calcium ion (Ca²⁺), or aluminum ion (Al³⁺). That is, in the multivalent-ion secondary battery, a plurality of electrons corresponding to the valence of positive ions (cations) can be taken out from one atom and used as electric energy. Therefore, excellent battery characteristics (high electric capacity, high energy density, etc.) are expected, as compared with a lithium ion secondary battery in which a lithium ion, i.e., a monovalent positive ion (cation), becomes an electrode reactant (a substance responsible for electric conduction during charging and discharging).

The sulfur contained in the positive electrode active material for multivalent-ion secondary battery according to the first embodiment of the present technology is sulfur coated with a polyethylene dioxythiophene-based conductive polymer doped with a sulfonic acid-based compound. The sulfur may be sulfur nanoparticles (sulfur nanospheres). The sulfur nanoparticles (sulfur nanospheres) are preferably spherical. The sulfur nanoparticles can be produced by various methods. For example, known methods include a method of reducing sodium sulfide in an aqueous solution in the presence of a suitable surfactant, a method of mixing sodium thiosulfate with an acid in an aqueous solution, and the like. Depending on the type of surfactant and the concentration of raw material, it is possible to control the particle size.

When the amount of the polyethylene dioxythiophene-based conductive polymer with which sulfur is coated is expressed by the mass ratio of sulfur (S) to polyethylene dioxythiophene-based conductive polymer (S:conductive polymer), the mass ratio may be an arbitrary ratio as long as improvement of battery characteristics can be achieved. The mass ratio is preferably 1:0.4 to 1:0.001, and more preferably 1:0.4 to 1:0.01.

The state in which the sulfur is coated with the polyethylene dioxythiophene-based conductive polymer may be a state in which the entire surface of the sulfur may be coated with the polyethylene dioxythiophene-based conductive polymer or may be a state in which at least a part of the surface of the sulfur is coated with the polyethylene dioxythiophene-based conductive polymer. Further, the polyethylene dioxythiophene-based conductive polymer may penetrate (adhere) to at least a part of the inside of the sulfur.

The polyethylene dioxythiophene-based conductive polymer is a conductive polymer obtained by doping poly(ethylenedioxy)thiophene (hereinafter, sometimes referred to as “PEDOT”) with a sulfonic acid-based compound. The poly(ethylenedioxy)thiophene (PEDOT) is also a conductive polymer and is represented by the following structural formula (1):

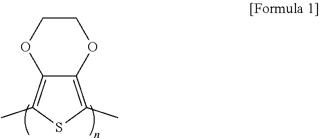

The sulfonic acid-based compound is not particularly limited as long as the sulfonic acid-based compound is a compound containing a sulfo group (—SO₃H), but specific examples thereof include polysulfonic acids such as camphorsulfonic acid, polystyrene sulfonic acid, polyvinylsulfonic acid, polyacryl sulfonic acid, polyvinyl sulfate, and polymethacryl sulfonic acid. Among the specific examples, the camphorsulfonic acid is preferred. It is to be noted that the polyvinyl sulfate has —O—SO₃H and contains a sulfo group (—SO₃H), so the polyvinyl sulfate is one of the specific examples of the sulfonic acid-based compound.

When the doping amount is expressed by the mass ratio of poly(ethylenedioxy)thiophene (PEDOT) to sulfonic acid-based compound (PEDOT:sulfonic acid-based compound), the mass ratio may be an arbitrary ratio as long as improvement of conductivity can be achieved. The mass ratio is preferably 1:0.2 to 1:100, and more preferably 1:0.5 to 1:25.

According to the positive electrode active material for multivalent-ion secondary battery of the first embodiment of the present technology, it is possible to obtain excellent battery characteristics. The positive electrode active material for multivalent-ion secondary battery according to the first embodiment of the present technology contributes to improvement in battery characteristics, and particularly contributes to improvement in electric capacity, improvement in cycle characteristics, and the like. Further, the positive electrode active material for multivalent-ion secondary battery according to the first embodiment of the present technology significantly contributes to improvement in initial electric capacity in the electric capacity, and particularly significantly contributes to improvement in initial discharge capacity in the initial electric capacity.

It is considered that since the polyethylene dioxythiophene-based conductive polymer obtained by doping poly(ethylenedioxy)thiophene (PEDOT) with a sulfonic acid-based compound is a conductive polymer, the polymer contributes to improvement in electronic conductivity of sulfur (i.e., an insulator) and contributes to improvement in reactivity of sulfur. The positive electrode active material for multivalent-ion secondary battery according to the first embodiment of the present technology including sulfur coated with a polyethylene dioxythiophene-based conductive polymer exhibits a high reaction efficiency than that of a positive electrode active material containing sulfur (untreated sulfur) which is not coated with the polyethylene dioxythiophene-based conductive polymer, and the reaction achieves almost the theoretical capacity of sulfur.

A positive electrode for multivalent-ion secondary battery according to a second embodiment of the present technology is a positive electrode for multivalent-ion secondary battery including at least a positive electrode active material, where the positive electrode active material contains sulfur, and the sulfur is coated with a polyethylene dioxythiophene-based conductive polymer doped with a sulfonic acid-based compound.

The sulfur contained in the positive electrode active material included at least in the positive electrode for multivalent-ion secondary battery according to the second embodiment of the present technology is sulfur coated with a polyethylene dioxythiophene-based conductive polymer doped with a sulfonic acid-based compound. The sulfur may be sulfur nanoparticles (sulfur nano spheres). The sulfur nanoparticles (sulfur nano spheres) are preferably spherical. The general method of producing sulfur nanoparticles is as described above.

When the amount of the polyethylene dioxythiophene-based conductive polymer with which sulfur is coated is expressed by the mass ratio of sulfur (S) to polyethylene dioxythiophene-based conductive polymer (S:conductive polymer), the mass ratio may be an arbitrary ratio as long as improvement of battery characteristics can be achieved. The mass ratio is preferably 1:0.4 to 1:0.001, and more preferably 1:0.4 to 1:0.01.

The state in which the sulfur is coated with the polyethylene dioxythiophene-based conductive polymer may be a state in which the entire surface of the sulfur may be coated with the polyethylene dioxythiophene-based conductive polymer or may be a state in which at least a part of the surface of the sulfur is coated with the polyethylene dioxythiophene-based conductive polymer. Further, the polyethylene dioxythiophene-based conductive polymer may penetrate (adhere) to at least a part of the inside of the sulfur.

As described above, the polyethylene dioxythiophene-based conductive polymer is a polymer obtained by doping poly(ethylenedioxy)thiophene (PEDOT) with a sulfonic acid-based compound. Further, the sulfonic acid-based compound is not particularly limited, and specific examples of the sulfonic acid-based compound are as described above, and among the specific examples, camphorsulfonic acid is preferred.

When the doping amount is expressed by the mass ratio of poly(ethylenedioxy)thiophene (PEDOT) to sulfonic acid-based compound (PEDOT:sulfonic acid-based compound), the mass ratio may be an arbitrary ratio as long as improvement of conductivity can be achieved. The mass ratio is preferably 1:0.2 to 1:100, and more preferably 1:0.5 to 1:25.

The positive electrode for multivalent-ion secondary battery according to the second embodiment of the present technology may include a current collector. The current collector may be formed of a conductive material such as aluminum, nickel, or stainless steel.

The positive electrode for multivalent-ion secondary battery according to the second embodiment of the present technology may include a binder. Examples of binders include binders containing any one of, or two or more of synthetic rubbers and polymer materials. Examples of synthetic rubbers include styrene-butadiene rubbers, fluorine rubbers, and ethylene propylene diene. Examples of polymer materials include polyvinylidene fluoride and polyimide.

The positive electrode for multivalent-ion secondary battery according to the second embodiment of the present technology may include a conductive agent. Examples of conductive agents include conductive agents containing any one of, or two or more of carbon materials. Examples of carbon materials include graphite, carbon black, acetylene black, and ketjen black. It is to be noted that the conductive agent may be a metal material, a conductive polymer, or the like as long as the agent is a conductive material.

The positive electrode for multivalent-ion secondary battery according to the second embodiment of the present technology may further include materials such as additives other than those described above.

According to the positive electrode for multivalent-ion secondary battery of the second embodiment of the present technology, it is possible to obtain excellent battery characteristics. The positive electrode for multivalent-ion secondary battery according to the second embodiment of the present technology contributes to improvement in battery characteristics, and particularly contributes to improvement in electric capacity, improvement in cycle characteristics, and the like. Further, the positive electrode for multivalent-ion secondary battery according to the second embodiment of the present technology significantly contributes to improvement in initial electric capacity in the electric capacity, and particularly significantly contributes to improvement in initial discharge capacity in the initial electric capacity.

It is considered that since the polyethylene dioxythiophene-based conductive polymer obtained by doping poly(ethylenedioxy)thiophene (PEDOT) with a sulfonic acid-based compound is a conductive polymer, the polymer contributes to improvement in electronic conductivity of sulfur (i.e., an insulator) and contributes to improvement in reactivity of sulfur. The positive electrode for multivalent-ion secondary battery according to the second embodiment of the present technology including at least a positive electrode active material containing sulfur coated with a polyethylene dioxythiophene-based conductive polymer exhibits a high reaction efficiency than that of a positive electrode including at least a positive electrode active material containing sulfur (untreated sulfur) which is not coated with the polyethylene dioxythiophene-based conductive polymer, and the reaction achieves almost the theoretical capacity of sulfur.

A positive electrode for multivalent-ion secondary battery according to a third embodiment of the present technology is a positive electrode for multivalent-ion secondary battery including at least a sulfur carbon composite containing sulfur and a carbon material, where the sulfur carbon composite is coated with a polyethylene dioxythiophene-based conductive polymer doped with a sulfonic acid-based compound.

The sulfur carbon composite included at least in the positive electrode for multivalent-ion secondary battery according to the third embodiment of the present technology includes sulfur and a carbon material. The sulfur may be contained as the positive electrode active material. The sulfur may be sulfur nanoparticles (sulfur nanospheres). The sulfur nanoparticles (sulfur nanospheres) are preferably spherical. Examples of carbon materials include graphite, carbon black, acetylene black, ketjen black, and the like, and a preferred example is ketjen black. Although the mass ratio of sulfur to carbon material in the sulfur carbon composite may be optional, the mass ratio is preferably 99:1 to 1:4, and more preferably 4:1 to 1:4. Because of this preferred mass ratio and more preferred mass ratio, the sulfur carbon composite can contribute to further improvement in electric capacity, further improvement in initial electric capacity in the electric capacity, and contributes to further improvement in initial discharge capacity in the initial electric capacity. The sulfur carbon composite is obtained by mixing sulfur and a carbon material.

The sulfur carbon composite included at least in the positive electrode for multivalent-ion secondary battery according to the third embodiment of the present technology is a sulfur carbon composite coated with a polyethylene dioxythiophene-based conductive polymer doped with a sulfonic acid-based compound. As described above, the polyethylene dioxythiophene-based conductive polymer is a polymer obtained by doping poly(ethylenedioxy)thiophene (PEDOT) with a sulfonic acid-based compound. Further, the sulfonic acid-based compound is not particularly limited, and specific examples of the sulfonic acid-based compound are as described above, and among the specific examples, polystyrene sulfonic acid is preferred.

When the amount of the polyethylene dioxythiophene-based conductive polymer with which a sulfur carbon composite is coated is expressed by the mass ratio of sulfur carbon composite to polyethylene dioxythiophene-based conductive polymer (conductive polymer) (sulfur carbon composite: conductive polymer), the mass ratio may be an arbitrary ratio as long as improvement of battery characteristics can be achieved. The mass ratio is preferably 1:0.4 to 1:0.001, and more preferably 1:0.4 to 1:0.01.

The state in which the sulfur carbon composite is coated with the polyethylene dioxythiophene-based conductive polymer may be a state in which the entire surface of the sulfur carbon composite may be coated with the polyethylene dioxythiophene-based conductive polymer or may be a state in which at least a part of the surface of the sulfur carbon composite is coated with the polyethylene dioxythiophene-based conductive polymer. Further, the polyethylene dioxythiophene-based conductive polymer may penetrate (adhere) to at least a part of the inside of the sulfur carbon composite.

When the doping amount is expressed by the mass ratio of poly(ethylenedioxy)thiophene (PEDOT) to sulfonic acid-based compound (PEDOT:sulfonic acid-based compound), the mass ratio may be an arbitrary ratio as long as improvement of conductivity can be achieved. The mass ratio is preferably 1:0.2 to 1:100, and more preferably 1:0.5 to 1:25.

The positive electrode for multivalent-ion secondary battery according to the third embodiment of the present technology may include a current collector. The current collector may be formed of a conductive material such as aluminum, nickel, or stainless steel.

The positive electrode for multivalent-ion secondary battery according to the third embodiment of the present technology may include a binder. Examples of binders include binders containing any one of, or two or more of synthetic rubbers and polymer materials. Examples of synthetic rubbers include styrene-butadiene rubbers, fluorine rubbers, and ethylene propylene diene. Examples of polymer materials include polyvinylidene fluoride and polyimide.

The positive electrode for multivalent-ion secondary battery according to the third embodiment of the present technology may include a conductive agent. Examples of conductive agents include conductive agents containing any one of, or two or more of carbon materials. Examples of carbon materials include graphite, carbon black, acetylene black, and ketjen black. It is to be noted that the conductive agent may be a metal material, a conductive polymer, or the like as long as the agent is a conductive material.

The positive electrode for multivalent-ion secondary battery according to the third embodiment of the present technology may further include materials such as additives other than those described above.

According to the positive electrode for multivalent-ion secondary battery of the third embodiment of the present technology, it is possible to obtain excellent battery characteristics. The positive electrode for multivalent-ion secondary battery according to the third embodiment of the present technology contributes to improvement in battery characteristics, and particularly contributes to improvement in electric capacity, improvement in cycle characteristics, and the like. Further, the positive electrode for multivalent-ion secondary battery according to the third embodiment of the present technology significantly contributes to improvement in initial electric capacity in the electric capacity, and particularly significantly contributes to improvement in initial discharge capacity in the initial electric capacity.

It is considered that since the polyethylene dioxythiophene-based conductive polymer obtained by doping poly(ethylenedioxy)thiophene (PEDOT) with a sulfonic acid-based compound is a conductive polymer, the polymer contributes to improvement in electronic conductivity of sulfur (i.e., an insulator) and contributes to improvement in reactivity of sulfur. The positive electrode for multivalent-ion secondary battery according to the third embodiment of the present technology including a sulfur carbon composite coated with a polyethylene dioxythiophene-based conductive polymer exhibits a high reaction efficiency than that of a positive electrode including a sulfur carbon composite (untreated sulfur carbon composite) which is not coated with the polyethylene dioxythiophene-based conductive polymer, the reaction achieves almost the theoretical capacity of sulfur.

A multivalent-ion secondary battery according to a fourth embodiment of the present technology includes the positive electrode for multivalent-ion secondary battery according to the second embodiment, a negative electrode, and an electrolytic solution, where the electrolytic solution includes a solvent containing sulfone and a metal salt dissolved in the solvent. The positive electrode for multivalent-ion secondary battery of the second embodiment included in the multivalent-ion secondary battery according to the fourth embodiment of the present technology is as described above.

The electrolytic solution included in the multivalent-ion secondary battery according to the fourth embodiment of the present technology includes a solvent containing sulfone and a metal salt dissolved in the solvent. The solvent containing sulfone may be a solvent composed of sulfone and at least one compound other than sulfone, or may be a solvent composed of sulfone.

The sulfone contained in the solvent containing sulfone is typically an alkyl sulfone or an alkylsulfone derivative represented by R₁R₂SO₂ (wherein R₁ and R₂ represent an alkyl group).

Here, the kind (the number and combination of carbon atoms) of R₁ and R₂ is not particularly limited, and is selected, if necessary. The number of carbon atoms of R₁ and R₂ is preferably 4 or less. The sum of the number of carbon atoms of R₁ and the number of carbon atoms of R₂ is preferably, although not limited to, 4 or more and 7 or less. R₁ and R₂ represent, for example, a methyl group, an ethyl group, an n-propyl group, an i-propyl group, an n-butyl group, an i-butyl group, an s-butyl group, a t-butyl group or the like. The alkyl sulfone is specifically at least one selected from the group consisting of dimethyl sulfone (DMS), methyl ethyl sulfone (MES), methyl-n-propylsulfone (MnPS), methyl-i-propylsulfone (MiPS), methyl-n-butylsulfone (MnBS), methyl-i-butylsulfone (MiBS), methyl-s-butylsulfone (MsBS), methyl-t-butylsulfone (MtBS), ethyl methyl sulfone (EMS), diethyl sulfone (DES), ethyl-n-propylsulfone (EnPS), ethyl-i-propylsulfone (EiPS), ethyl-n-butylsulfone (EnBS), ethyl-i-butylsulfone (EiBS), ethyl-s-butylsulfone (EsBS), ethyl-t-butylsulfone (EtBS), di-n-propylsulfone (DnPS), di-i-propylsulfone (DIPS), n-propyl-n-butylsulfone (nPnBS), n-butylethylsulfone (nBES), i-butylethylsulfone (iBES), s-butylethylsulfone (sBES), and di-n-butylsulfone (DnBS). The alkyl sulfone derivative is, for example, ethyl phenyl sulfone (EPhS).

The solvent containing sulfone may contain a nonpolar solvent. The nonpolar solvent is selected, if necessary, and is preferably a nonaqueous solvent in which both the dielectric constant and the number of donors are 20 or less. More specifically, the nonpolar solvent is at least one selected from the group consisting of aromatic hydrocarbons, ethers, ketones, esters, and chain carbonate esters. The aromatic hydrocarbon is, for example, toluene, benzene, o-xylene, m-xylene, p-xylene, 1-methylnaphthalene or the like. Ether is, for example, diethyl ether, tetrahydrofuran, or the like. Ketone is, for example, 4-methyl-2-pentanone, or the like. Ester is, for example, methyl acetate or ethyl acetate, or the like. The chain carbonate may be, for example, dimethyl carbonate, diethyl carbonate, ethyl methyl carbonate, or the like.

The metal contained in the metal salt may be any metal as long as the metal is a metal which produces divalent or higher valent positive ions when ionized, and a metal salt of Group II element such as magnesium (Mg) salt and calcium (Ca) salt, a metal salt of another light metal such as aluminum (Al), and the like are preferred, and the magnesium (Mg) salt is more preferred.

The magnesium salt includes, for example, at least one selected from the group consisting of magnesium chloride (MgCl₂), magnesium bromide (MgBr₂), magnesium iodide (MgI₂), magnesium perchlorate (Mg(ClO₄)₂)₂), magnesium tetrafluoroborate (Mg(BF₄)₂), magnesium hexafluorophosphate (Mg(PF₆)₂), magnesium hexafluoroarsenate (Mg(AsF₆)₂), magnesium perfluoroalkylsulfonate (Mg(Rf1SO₃)₂; in which Rf1 is a perfluoroalkyl group) and magnesium perfluoroalkylsulfonylimidate (Mg((Rf2SO₂)₂N)₂; in which Rf2 is a perfluoroalkyl group), magnesium hexaalkyl disiazide ((Mg(HRDS)₂); in which R is an alkyl group). Among these magnesium salts, MgX₂ (X=Cl, Br, I) is particularly preferred.

The electrolytic solution may further contain an additive, if necessary.

The additive is, for example, a salt in which a metal ion includes a positive ion of at least one atom or atomic group selected from the group consisting of lithium (Li), aluminum (Al), beryllium (Be), boron (B), gallium (Ga), indium (In), silicon (Si), tin (Sn), titanium (Ti), chromium (Cr), iron (Fe), cobalt (Co), and lanthanum (La). Alternatively, the additive may be a salt including at least one atom, organic group, or negative ion selected from the group consisting of a hydrogen, an alkyl group, an alkenyl group, an aryl group, a benzyl group, an amide group, a fluoride ion (F⁻), a chloride ion (Cl⁻), a bromide ion (Br⁻), an iodide ion(I⁻), a perchlorate ion (ClO₄⁻), a tetrafluoroborate ion (BF₄⁻), a hexafluorophosphate ion (PF₆⁻), a hexafluoroarsenate ion (AsF₆⁻), a perfluoroalkylsulfonate ion (Rf1SO₃⁻; in which Rf1 is a perfluoroalkyl group), and a perfluoroalkylsulfonylimide ion (Rf2SO₂)₂N⁻; in which Rf2 is a perfluoroalkyl group). This additive is added so that it is possible to improve the ionic conductivity of the electrolytic solution.

A molar ratio of a sulfone to a magnesium salt in an electrolytic solution is, although not limited to, for example, 4 or more and 35 or less, typically 6 or more and 16 or less, and preferably 7 or more and 9 or less. The electrolytic solution typically contains a magnesium complex having a tetra-coordinated dimer structure in which the sulfone is coordinated to magnesium.

A method of producing an electrolytic solution can be performed, for example, in the following manner.

First, a magnesium salt is dissolved in alcohol. As the magnesium salt, an anhydrous magnesium salt is preferably used. Normally, the magnesium salt is not dissolved in a sulfone, but is dissolved well in the alcohol. Thus, when the magnesium salt is dissolved in the alcohol, the alcohol is coordinated to magnesium. The alcohol is selected, if necessary, for example, from the alcohol already mentioned. As the alcohol, a dehydrated alcohol is preferably used. Subsequently, a sulfone is dissolved in the solution in which the magnesium salt is dissolved in the alcohol. Thereafter, the alcohol is removed by heating the solution under reduced pressure. In the process of removing the alcohol in this manner, the alcohol coordinated to magnesium is exchanged (or replaced) with the sulfone. The desired electrolytic solution is produced in the above manner.

It is possible to obtain a magnesium ion-containing nonaqueous electrolytic solution which can be used for a magnesium metal and exhibits an electrochemically reversible precipitation and dissolution reaction of magnesium at room temperature using sulfone which is a nonether type solvent. Since this electrolytic solution generally has a higher boiling point than an ether solvent such as THF, and sulfone having low volatility and high safety is used as a solvent, it is easy to handle the electrolytic solution, whereby it is possible to greatly simplify the process of producing a magnesium-ion battery, for example. Further, since the potential window of this electrolytic solution is wider than the conventional magnesium electrolytic solution obtained by using THF as a solvent, the choice of the positive electrode material of the magnesium-ion secondary battery is widened and the voltage of the secondary battery, i.e., the energy density can be improved. Furthermore, since the composition of the electrolytic solution is simple, the cost of the electrolytic solution itself can be greatly reduced.

Further, another method of producing an electrolytic solution can be performed, for example, in the following manner.

First, a magnesium salt is dissolved in alcohol. As a result, the alcohol coordinates to the magnesium. As the magnesium salt, an anhydrous magnesium salt is preferably used. The alcohol is selected, if necessary, for example, from the alcohol already mentioned. Subsequently, a sulfone is dissolved in the solution in which the magnesium salt is dissolved in the alcohol. Then, the alcohol is removed by heating the solution under reduced pressure. In the process of removing the alcohol in this manner, the alcohol coordinated to magnesium is exchanged with the sulfone. Thereafter, a nonpolar solvent is mixed with the solution from which the alcohol has been removed. The nonpolar solvent is selected, if necessary, for example, from the nonpolar solvents already mentioned. The desired electrolytic solution is produced in the above manner.

As the negative electrode included in the multivalent-ion secondary battery according to the fourth embodiment of the present technology, a negative electrode made of a simple substance of metal which becomes a multivalent ion (a positive ion having a valence of 2 or more, the same shall apply hereinafter) when ionized, or made of an alloy containing the metal which becomes a multivalent ion is used. Examples of the metal which becomes a multivalent ion include Group II element metals such as magnesium and calcium and other light metals such as aluminum, and metals made of simple substances of the metals or made of alloys of the metals are used. Preferably, as the metal which becomes a multivalent ion, a metal made of a magnesium metal simple substance or a magnesium alloy is used, and the metal is typically formed into a plate or foil shape, and the metal, although not limited thereto, can be formed using powders. As the negative electrode, a plating foil plated with a magnesium metal simple substance, a magnesium alloy, or the like may be used.

The negative electrode included in the multivalent-ion secondary battery according to the fourth embodiment of the present technology may include the current collector, the binder, and the conductive agent as mentioned above.

The multivalent-ion secondary battery according to the fourth embodiment of the present technology may include a separator. The separator separates the positive electrode and the negative electrode, and enables multivalent-ions (e.g., magnesium ions in the case of a magnesium-ion secondary battery) to pass while preventing short circuit of the current caused by the contact of the electrodes. This separator is, for example, a porous membrane of any one of a synthetic resin, a ceramic, a glass filter and the like, and may be a laminated film using two or more porous membranes. The synthetic resin is, for example, any one of, or two or more of polytetrafluoroethylene, polypropylene, polyethylene and the like.

Particularly, the separator may include, for example, the above-mentioned porous membrane (base material layer), and a polymer compound layer provided on one side or both sides of the base material layer. The adhesion of the separator to the positive and negative electrodes can be improved. Thus, the inhibited decomposition reaction of the electrolytic solution, and also, the suppressed leakage of the electrolytic solution with which the base material layer impregnated, make the electric resistance less likely to increase even with repeated charging/discharging, and suppress the swelling of the battery.

The polymer compound layer includes, for example, a polymer material such as polyvinylidene fluoride. This is because the polymer material is excellent in physical strength, and electrochemically stable. However, the polymer material may be a material other than polyvinylidene fluoride. In the case of forming the polymer compound layer, for example, a solution including a polymer material dissolved therein is applied to the base material layer, and then the base material layer is dried. It is to be noted that after immersing the base material layer in the solution, the base material layer may be dried.

The shape of the multivalent-ion secondary battery according to the fourth embodiment of the present technology is not particularly limited, and examples thereof include a coin type, a button type, a sheet type, a laminated type, a cylindrical type, a flat type, and a square type. Further, a large-sized multivalent-ion secondary battery may be applied to a battery pack, an electric vehicle, a power storage system, a power tool, an electronic device, or the like. The method of producing the multivalent-ion secondary battery according to the fourth embodiment of the present technology varies depending on the shape of the multivalent-ion secondary battery, but can be performed by a known method, and for example, it is possible to produce a coin-type multivalent-ion secondary battery by placing a gasket on a coin battery can, stacking a positive electrode, a separator, a negative electrode, a spacer made of a stainless steel plate, and a coin battery lid in this order, previously allowing the spacer to be spot-welded to the coin battery lid, and sealing the coin battery can by caulking.

The operation of the multivalent-ion secondary battery according to the fourth embodiment of the present technology will be described. Here, the operation of the magnesium-ion battery, which is an example of the multivalent-ion secondary battery according to the fourth embodiment of the present technology, will be described.

In the magnesium-ion battery, which is an example of the multivalent-ion secondary battery according to the fourth embodiment of the present technology, magnesium ions (Mg²⁺) transfer from the positive electrode to the negative electrode through the electrolytic solution during charging, whereby electrical energy is converted to chemical energy, and electricity is stored. During discharging, magnesium ions return from the negative electrode to the positive electrode through the electrolytic solution, thereby generating electric energy.

The multivalent-ion secondary battery according to the fourth embodiment of the present technology has excellent battery characteristics. Particularly, the multivalent-ion secondary battery according to the fourth embodiment of the present technology has an effect of high electric capacity, excellent cycle characteristics, and the like. Further, the multivalent-ion secondary battery according to the fourth embodiment of the present technology significantly exerts the effect of high initial electric capacity in electric capacity, and particularly significantly exerts the effect of high initial discharge capacity in initial electric capacity.

When the multivalent-ion secondary battery according to the fourth embodiment of the present technology is driven using sulfur coated with a polyethylene dioxythiophene-based conductive polymer, the reaction efficiency is higher than when the multivalent-ion secondary battery is driven using sulfur (untreated sulfur) which is not coated with the polyethylene dioxythiophene-based conductive polymer, and the reaction achieves almost the theoretical capacity of sulfur.

When sulfur coated with a polyethylene dioxythiophene-based conductive polymer is used, the open circuit voltage is maintained high as compared with when sulfur (untreated sulfur) which is not coated with the polyethylene dioxythiophene-based conductive polymer is used, and thus it is considered that elution of sulfur into the electrolytic solution is suppressed, and this also contributes to the improvement in the initial electric capacity, particularly the initial discharge amount.

In the case of a magnesium-ion battery which is an example of the multivalent-ion secondary battery, it is sometimes important to use an electrolytic solution which is not an arbitrary electrolytic solution and which contains a solvent containing sulfone (preferably a solvent containing ethyl-n-propyl sulfone (EnPS)) rather than the generally used Grignard-based electrolytic solution, in order to sufficiently improve the reaction efficiency of sulfur.

A multivalent-ion secondary battery according to a fifth embodiment of the present technology includes the positive electrode for multivalent-ion secondary battery according to the third embodiment, a negative electrode, and an electrolytic solution, where the electrolytic solution includes a solvent containing sulfone and a metal salt dissolved in the solvent. The positive electrode for multivalent-ion secondary battery of the third embodiment included in the multivalent-ion secondary battery according to the fifth embodiment of the present technology is as described above.

The electrolytic solution, the solvent containing sulfone contained in the electrolytic solution, the metal salt, the negative electrode, and the separator included in the multivalent-ion secondary battery according to the fifth embodiment of the present technology are as described in the fourth embodiment. The shape and production method of the multivalent-ion secondary battery according to the fifth embodiment of the present technology as well as the operation of the multivalent-ion secondary battery according to the fifth embodiment of the present technology are as described in the fourth embodiment.

The multivalent-ion secondary battery according to the fifth embodiment of the present technology has excellent battery characteristics. Particularly, the multivalent-ion secondary battery according to the fifth embodiment of the present technology has an effect of high electric capacity, excellent cycle characteristics, and the like. Further, the multivalent-ion secondary battery according to the fifth embodiment of the present technology significantly exerts the effect of high initial electric capacity in electric capacity, and particularly significantly exerts the effect of high initial discharge capacity in initial electric capacity.

When the multivalent-ion secondary battery according to the fifth embodiment of the present technology is driven using a sulfur carbon composite coated with a polyethylene dioxythiophene-based conductive polymer, the reaction efficiency is higher than when the multivalent-ion secondary battery is driven using a sulfur carbon composite (untreated sulfur carbon composite) which is not coated with the polyethylene dioxythiophene-based conductive polymer, and the reaction achieves almost the theoretical capacity of sulfur.

When a sulfur carbon composite coated with a polyethylene dioxythiophene-based conductive polymer is used, the open circuit voltage is maintained high as compared with when a sulfur carbon composite (untreated sulfur carbon composite) which is not coated with the polyethylene dioxythiophene-based conductive polymer is used, and thus it is considered that elution of sulfur into the electrolytic solution is suppressed, and this also contributes to the improvement in the initial electric capacity, particularly the initial discharge capacity.

In the case of a magnesium-ion battery which is an example of the multivalent-ion secondary battery, it is sometimes important to use an electrolytic solution which is not an arbitrary electrolytic solution and which contains a solvent containing sulfone (preferably a solvent containing ethyl-n-propyl sulfone (EnPS)) rather than the generally used Grignard-based electrolytic solution, in order to sufficiently improve the reaction efficiency of sulfur.

Conventionally, the magnesium-ion secondary battery (Mg—S battery) using a positive electrode including sulfur (untreated sulfur) had a reaction efficiency of about 1100 to 1200 mAh/g with respect to the theoretical capacity of sulfur (1670 mAh). This is generally thought to be due to a decrease in reaction efficiency caused by poor electronic conductivity of sulfur and elution of sulfur into the electrolytic solution. The technology for imparting high electron conductivity to sulfur and the technology for suppressing elution are considered to be essential to develop a multivalent-ion secondary battery having high electric capacity and high energy density, particularly a magnesium-ion secondary battery (Mg—S battery). It is to be noted that regarding the technology for using PEDOT, there is a report on improvement in cycle characteristics of a monovalent-ion secondary battery (e.g., a lithium ion secondary battery (Li—S battery)), but there is no report on improvement in the electric capacity, particularly improvement in the initial discharge capacity. The battery system is not a monovalent-ion secondary battery (e.g., a lithium ion secondary battery (Li—S battery)), but a multivalent-ion secondary battery, particularly a magnesium-ion secondary battery (Mg—S battery) and includes a different electrolytic solution, and therefore, a new tendency different from the known example of the monovalent-ion secondary battery (e.g., a lithium ion secondary battery (Li—S battery)) is considered to be exhibited.

The application of the multivalent-ion secondary battery will be described in detail.

The application of the multivalent-ion secondary battery is not particularly limited, as long as the multivalent-ion secondary battery is applied to machines, devices, instruments, apparatuses, systems, and the like (assembly of multiple devices or the like) that can use the multivalent-ion secondary battery as a driving power supply, a power storage source for reserve of power, or the like.

The multivalent-ion secondary battery used as a power supply may be a main power supply (a power supply to be used preferentially) or an auxiliary power supply (a power supply which is used in place of the main power supply or by being switched from the main power supply). When the multivalent-ion secondary battery is used as an auxiliary power supply, the type of the main power supply is not limited to the secondary battery.

Here are applications of the multivalent-ion secondary battery, for example: electronic devices (including portable electronic devices) such as video cameras, digital still cameras, cellular phones, laptop personal computers, cordless telephones, headphone stereos, portable radios, portable televisions, and portable information terminals; portable life instruments such as electric shavers; storage devices such as backup power supplies and memory cards; power tools such as electric drills and electric saws; battery packs used for notebook-type personal computers or the like as a detachable power supply; medical electronic devices such as pacemakers and hearing aids; electric vehicles such as electric cars (including hybrid cars); and power storage systems such as a domestic battery system that stores electric power in preparation for emergency or the like. Of course, the application of the multivalent-ion secondary battery may be any other application than the foregoing.

Above all, it is effective to apply the multivalent-ion secondary battery to a battery pack, an electric vehicle, a power storage system, a power tool, an electronic device, or the like. This is because, excellent battery characteristics are required, the use of the multivalent-ion secondary battery according to the present technology can improve the performance in an effective manner. It is to be noted that the battery pack is a power source using a multivalent-ion secondary battery, and is a so-called assembled battery or the like. The electric vehicle is a vehicle that operates (travels) with the multivalent-ion secondary battery as a driving power supply, and may be a vehicle (a hybrid car or the like) also provided with a driving source other than the multivalent-ion secondary battery as mentioned above. The power storage system is a system using a multivalent-ion secondary battery as a power storage source. For example, for a household power storage system, electric power is stored in the multivalent-ion secondary battery which serves as a power storage source, thus making it possible to use home electric appliances and the like through the use of electric power. The power tool is a tool which makes a movable part (such as a drill, for example) movable with the multivalent-ion secondary battery as a driving power supply. The electronic device is a device that performs various functions with the multivalent-ion secondary battery as a driving power supply (power supply source).

In this regard, some application examples of the multivalent-ion secondary battery will be specifically described. It is to be noted that the configuration of each application example described below is just considered by way of example, and the configuration can be thus changed appropriately.

A battery pack according to a sixth embodiment of the present technology includes the multivalent-ion secondary batteries according to the fourth and fifth embodiments of the present technology, a control unit that controls the usage state of the multivalent-ion secondary battery, and a switch unit that switches the usage state of the multivalent-ion secondary battery in response to an instruction from the control unit. The battery pack according to the sixth embodiment of the present technology includes the multivalent-ion secondary batteries according to the fourth and fifth embodiments of the present technology having excellent battery characteristics, which leads to improved performance of the battery pack.

Hereinafter, the battery pack according to the sixth embodiment of the present technology will be described with reference to the drawings.

FIG. 6 shows a block configuration of the battery pack. This battery pack includes, for example, inside a housing 60 formed of a plastic material, a control unit 61 (controller), a power supply 62, a switch unit 63, a current measurement unit 64, a temperature detection unit 65, a voltage detection unit 66, a switch control unit 67, a memory 68, a temperature detection element 69, a current detection resistor 70, a positive electrode terminal 71, and a negative electrode terminal 72.

The control unit 61 is configured to control the operation of the entire battery pack (including the usage state of the power supply 62), and includes, for example, a central processing unit (CPU) and the like. The power supply 62 includes one or more multivalent-ion secondary batteries (not shown). The power supply 62 is, for example, an assembled battery including two or more multivalent-ion secondary batteries, and the connection form of the secondary batteries may be a connection in series, a connection in parallel, or a mixed type of the both. To give an example, the power supply 62 includes six multivalent-ion secondary batteries connected in the form of two in parallel and three in series.

In response to an instruction from the control unit 61, the switch unit 63 switches the usage state of the power supply 62 (whether there is a connection between the power supply 62 and an external device. This switch unit 63 includes, for example, a charge control switch, a discharge control switch, a charging diode, a discharging diode (all of them are not shown), and the like. The charge control switch and the discharge control switch serve as, for example, semiconductor switches such as a field effect transistor (MOSFET) using a metal oxide semiconductor.

The current measurement unit 64 measures current through the use of the current detection resistor 70, and outputs the measurement result to the control unit 61. It is configured that the temperature detection unit 65 measures a temperature through the use of the temperature detection element 69, and outputs the measurement result to the control unit 61. The temperature measurement result is used, for example, when the control unit 61 controls charge/discharge in the case of abnormal heat generation, when the control unit 61 executes correction processing in the case of remaining capacity calculation, and the like. The voltage detection unit 66 measures the voltage of the multivalent-ion secondary battery in the power supply 62, analog-digital converts the measured voltage, and supplies the voltage to the control unit 61.

The switch control unit 67 controls the operation of the switch unit 63 in response to the signals input from the current measurement unit 64 and the voltage detection unit 66.

For example, when the battery voltage reaches the overcharge detection voltage, the switch control unit 67 disconnects the switch unit 63 (charge control switch), thereby preventing any charging current from flowing through the current path of the power supply 62. Thus, only discharge is allowed via the discharging diode in the power supply 62. It is to be noted that, for example, when a large current flows during charging, the switch control unit 67 is configured to shut off the charging current.

In addition, for example, when the battery voltage reaches the overdischarge detection voltage, the switch control unit 67 disconnects the switch unit 63 (discharge control switch), thereby preventing any discharging current from flowing through the current path of the power supply 62. Thus, only charge is allowed via the charging diode in the power supply 62. It is to be noted that, for example, when a large current flows during discharging, the switch control unit 67 is configured to shut off the discharging current.

It is to be noted that, in the multivalent-ion secondary battery, for example, the overcharge detection voltage is 4.2 V±0.05 V and the overdischarge detection voltage is 2.4 V±0.1 V.

The memory 68 is, for example, an EEPROM that is a non-volatile memory, or the like. This memory 68 stores, for example, numerical values calculated by the control unit 61, information on the multivalent-ion secondary battery, measured at the stage of manufacturing process (for example, internal resistance in the initial state, etc.), and the like. Further, storing the full charge capacity of the multivalent-ion secondary battery in the memory 68 makes it possible for the control unit 61 to grasp information such as the remaining capacity.

The temperature detection element 69 measures the temperature of the power supply 62 and outputs the measurement result to the control unit 61, and is, for example, a thermistor or the like.

The positive electrode terminal 71 and the negative electrode terminal 72 are terminals connected to an external device (for example, a laptop personal computer, etc.) operated through the use of the battery pack, an external device (for example, a charger, etc.) used for charging the battery pack, or the like. The power supply 62 is charged and discharged via the positive electrode terminal 71 and the negative electrode terminal 72.

An electric vehicle of a seventh embodiment according to the present technology is an electric vehicle including: the multivalent-ion secondary batteries according to the fourth and fifth embodiments of the present technology; a conversion unit which converts electric power supplied from the multivalent-ion secondary battery to driving force; a driving unit which drives in response to the driving force; and a control unit which controls a usage state of the multivalent-ion secondary battery. The electric vehicle of the seventh embodiment according to the present technology includes the multivalent-ion secondary batteries according to the fourth and fifth embodiments of the present technology having excellent battery characteristics, which leads to improved performance of the electric vehicle.

Hereinafter, the electric vehicle according to the seventh embodiment of the present technology will be described with reference to the drawings.

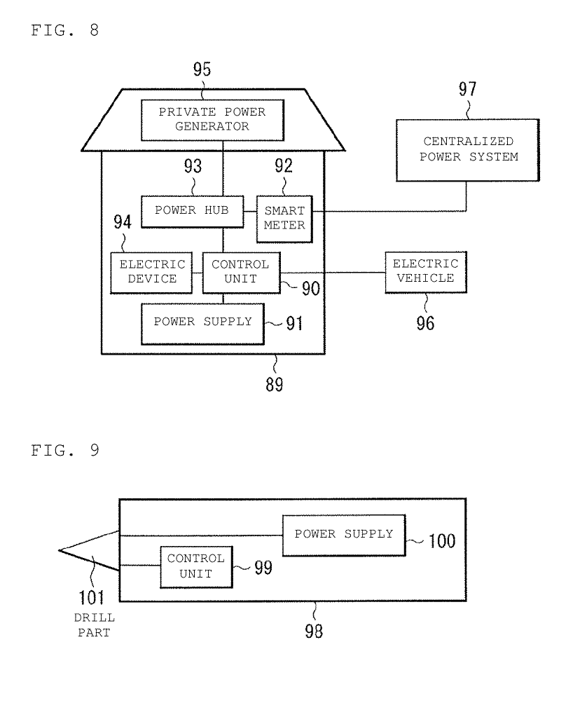

FIG. 7 shows a block configuration of a hybrid car as an example of an electric vehicle. The electric vehicle includes, for example, inside a metallic housing 73, a control unit 74, an engine 75, a power supply 76, a motor 77 for driving, a differential device 78, a power generator 79, a transmission 80 and a clutch 81, inverters 82, 83, and various sensors 84. Besides, the electric vehicle includes, for example, a front-wheel drive shaft 85 and front wheels 86 connected to the differential device 78 and the transmission 80, and a rear-wheel drive shaft 87 and rear wheels 88.

This electric vehicle can run, for example, using either the engine 75 or the motor 77 as a drive source. The engine 75 is a main power source, for example, a gasoline engine or the like. When the engine 75 is adopted as a power source, the driving force (torque) of the engine 75 is transmitted to the front wheels 86 or the rear wheels 88 via, for example, the differential device 78, the transmission 80, and the clutch 81 which are driving units. It should be understood that the torque of the engine 75 is transmitted to the power generator 79, the power generator 79 thus generates alternating-current power by the use of the torque, and the alternating-current power is converted to direct-current power via the inverter 83, and thus stored in the power supply 76. On the other hand, when the motor 77 as a conversion unit (converter) is adopted as a power source, the power (direct-current power) supplied from the power supply 76 is converted to alternating-current power via the inverter 82, and the motor 77 is thus driven by the use of the alternating-current power. The driving force (torque) converted from the power by the motor 77 is transmitted to the front wheels 86 or the rear wheels 88 via, for example, the differential device 78, the transmission 80, and the clutch 81 which are driving units.

It should be understood that the electric vehicle may be configured such that when the electric vehicle is decelerated via a braking mechanism (not shown), the resistance force at the time of deceleration is transmitted as a torque to the motor 77, and the motor 77 generates alternating-current power by the use of the torque. This alternating-current power is converted to direct-current power via the inverter 82, and the direct-current regenerative power is preferably stored in the power supply 76.

The control unit 74 (controller) controls the operation of the entire electric vehicle, and includes, for example, a CPU and the like. The power supply 76 includes one or more secondary batteries (not shown). The power supply 76 may be connected to an external power supply, and supplied with electric power from the external power supply to store the electric power. The various sensors 84 are used, for example, for controlling the rotation speed of the engine 75, and controlling the opening (throttle opening) of a throttle valve (not shown). The various sensors 84 include, for example, a speed sensor, an acceleration sensor, an engine speed sensor, and the like.

It should be understood that although a case where the electric vehicle is a hybrid car has been explained, the electric vehicle may be a vehicle (electric car) that operates through the use of only the power supply 76 and the motor 77 without using the engine 75.

A power storage system according to an eighth embodiment of the present technology is a power storage system including: the multivalent-ion secondary batteries according to the fourth and fifth embodiments of the present technology; one or more electric devices in which electric power is supplied from the multivalent-ion secondary battery; and a control unit which controls supply of power from the multivalent-ion secondary battery to the electric devices. The power storage system according to the eighth embodiment of the present technology includes the multivalent-ion secondary batteries according to the fourth and fifth embodiments of the present technology having excellent battery characteristics, which leads to improved performance of power storage.

Hereinafter, the power storage system according to the eighth embodiment of the present technology will be described with reference to the drawings.

FIG. 8 shows a block configuration of a power storage system. This power storage system includes, for example, a control unit 90, a power supply 91, a smart meter 92, and a power hub 93 inside a house 89 such as a general house and a commercial building.

In this regard, the power supply 91 is connected to, for example, an electric device 94 installed inside the house 89, and connectable to an electric vehicle 96 parked outside the house 89. Further, the power supply 91 is, for example, connected via the power hub 93 to a private power generator 95 installed in the house 89, and connectable to an external centralized power system 97 via the smart meter 92 and the power hub 93.

It should be understood that the electric device 94 includes, for example, one or more home electric appliances, and the home electric appliances may be, for example, a refrigerator, an air conditioner, a television, and a water heater. The private power generator 95 is, for example, one or more of a solar power generator, a wind power generator, and the like. The electric vehicle 96 is, for example, one or more of an electric car, an electric bike, a hybrid car, and the like. The centralized power system 97 is, for example, one or more of a thermal power plant, a nuclear power plant, a hydraulic power plant, a wind power plant, and the like.

The control unit 90 (controller) controls the operation of the entire power storage system (including the usage state of the power supply 91), and includes, for example, a CPU, a processor and the like. The power supply 91 includes one or more secondary batteries (not shown). The smart meter 92 is, for example, a network-compatible power meter installed in the house 89 of the power customer, which is capable of communicating with the power supplier. Accordingly, the smart meter 92 controls the balance between demand and supply of electric power in the house 89 while communicating with the outside, thereby allowing efficient and stable supply of energy.

In this power storage system, for example, power is stored in the power supply 91 via the smart meter 92 and the power hub 93 from the centralized power system 97, which is an external power supply, and power is stored in the power supply 91 via the power hub 93 from the solar power generator 95, which is an independent power supply. The electric power stored in the power supply 91 is supplied to the electric device 94 and the electric vehicle 96 in response to an instruction from the control unit 90, thus allowing the operation of the electric device 94, and allowing the electric vehicle 96 to be charged. More specifically, the power storage system is a system that allows power to be stored and supplied in the house 89 with the use of the power supply 91.

The electric power stored in the power supply 91 can be arbitrarily used. For this reason, for example, electric power can be stored in the power supply 91 from the centralized power system 97 at midnight when the electricity charge is inexpensive, and the electric power stored in the power supply 91 can be used during the day when the electricity charge is expensive.

It should be understood that the power storage system mentioned above may be installed for every single house (one household), or may be installed for every multiple houses (multiple households).

A power tool according to a ninth embodiment of the present technology is a power tool including the multivalent-ion secondary batteries according to the fourth and fifth embodiments of the present technology and a movable part to which electric power is supplied from the multivalent-ion secondary battery. The power tool according to the ninth embodiment of the present technology includes the multivalent-ion secondary batteries according to the fourth and fifth embodiments of the present technology having excellent battery characteristics, which leads to improved performance of the power tool.

Hereinafter, the power tool according to the ninth embodiment of the present technology will be described with reference to the drawings.

FIG. 9 shows a block configuration of a power tool. The power tool is, for example, an electric drill, and includes a control unit 99 (controller) and a power supply 100 inside a tool body 98 formed of a plastic material or the like. For example, a drill part 101 as a movable part is operatably (rotatably) attached to the tool body 98.

The control unit 99 controls the operation of the entire power tool (including the usage state of the power supply 100), and includes, for example, a CPU, a processor and the like. The power supply 100 includes one or more secondary batteries (not shown). The control unit 99 is configured to supply electric power from the power supply 100 to the drill part 101 in response to an operation of an operation switch (not shown).

An electronic device according to a tenth embodiment of the present technology is an electronic device including the multivalent-ion secondary batteries according to the fourth and fifth embodiments of the present technology as power supply sources. As described above, the electronic device according to the tenth embodiment of the present technology is a device that performs various functions with the multivalent-ion secondary battery as a driving power supply (power supply source). The electronic device according to the tenth embodiment of the present technology includes the multivalent-ion secondary batteries according to the fourth and fifth embodiments of the present technology having excellent battery characteristics, which leads to improved performance of the electronic device.

Since the effect of the present technology can be obtained without depending on the type of electrode reactant as long as the electrode reactant is an electrode reactant used for a multivalent-ion secondary battery, the same effect can be obtained even if the type of the electrode reactant is changed.

Further, the effects described in this description are merely considered by way of example, and other suitable properties relating to the present technology may be realized there may be other effects.

The present technology is described below in further detail according to an embodiment:

(1)

A positive electrode active material for multivalent-ion secondary battery including sulfur, where the sulfur is coated with a polyethylene dioxythiophene-based conductive polymer doped with a sulfonic acid-based compound;

(2)

A positive electrode for multivalent-ion secondary battery including at least a positive electrode active material, where the positive electrode active material contains sulfur, and the sulfur is coated with a polyethylene dioxythiophene-based conductive polymer doped with a sulfonic acid-based compound;

(3)

A positive electrode for multivalent-ion secondary battery including at least a sulfur carbon composite containing sulfur and a carbon material, where the sulfur carbon composite is coated with a polyethylene dioxythiophene-based conductive polymer doped with a sulfonic acid-based compound;

(4)

A multivalent-ion secondary battery including: the positive electrode for multivalent-ion secondary battery according to (2) or (3); a negative electrode; and an electrolytic solution, where the electrolytic solution includes a solvent containing sulfone and a metal salt dissolved in the solvent;

(5)

The multivalent-ion secondary battery according to (4), where the metal salt is a magnesium salt;

(6)

A battery pack including: the multivalent-ion secondary battery according to (4) or (5); a control unit which controls a usage state of the multivalent-ion secondary battery; and a switch unit which switches the usage state of the multivalent-ion secondary battery in response to an instruction from the control unit;

(7)

An electric vehicle including: the multivalent-ion secondary battery according to (4) or (5); a conversion unit which converts electric power supplied from the multivalent-ion secondary battery to driving force; a driving unit which drives in response to the driving force; and a control unit which controls a usage state of the multivalent-ion secondary battery;

(8)

A power storage system including: the multivalent-ion secondary battery according to (4) or (5); one or more electric devices in which electric power is supplied from the multivalent-ion secondary battery; and a control unit which controls supply of power from the multivalent-ion secondary battery to the electric devices;

(9)

A power tool including: the multivalent-ion secondary battery according to (4) or (5); and a movable part to which electric power is supplied from the multivalent-ion secondary battery; and

(10)

An electronic device including the multivalent-ion secondary battery according to (4) or (5) as a power supply source.

### EXAMPLES

Hereinafter, the effects of the present technology will be specifically described with examples. The scope of the present technology is not limited to the examples.

According to Example 1 and Comparative Example 1 below, a pellet positive electrode was produced by using sulfur nanoparticles (S-PEDOT nanospheres) coated with a poly(ethylenedioxy)thiophene conductive polymer obtained by doping poly(ethylenedioxy)thiophene (PEDOT) with camphorsulfonic acid as positive electrode active materials, and a pellet positive electrode was produced by using untreated sulfur (Bare S). Then, coin battery cells were produced using the pellet positive electrodes produced in Example 1 and Comparative Example 1, and battery characteristics were evaluated.

### Example 1

1. Synthesis of S-PEDOT Nanosphere

50 mL of an 80 mM Na₂S₂O₃ aqueous solution (Wako Pure Chemical Industries Ltd., Cat No. 190-15165) and 50 mL of a 0.4 M PVP aqueous solution (Mw. 55,000, Sigma Aldrich Co. LLC, Cat No. 856568) were stirred at room temperature. Thereafter, 0.4 mL of concentrated hydrochloric acid was added dropwise to the Na₂S₂O₃/PVP mixture and stirred. After stirring the mixture at room temperature for 2 hours, the product (PVP nanospheres) was centrifuged at 7000 rpm for 10 minutes. The precipitate was resuspended in a 0.8 M PVP solution, and then the PVP nanospheres were precipitated by centrifugation at 6000 rpm for 15 minutes and the precipitated nanospheres were recovered. In the PEDOT coating of PVP nanospheres, PVP nanospheres were first suspended in 100 mL of water, and then 110 μL of EDOT monomer (ethylenedioxythiophene) (Tokyo Chemical Industry Co., Ltd., Cat No. E0741), 0.1 g of camphorsulfonic acid (Tokyo Chemical Industry Co., Ltd., Cat No. C0016), and 0.6 g of (NH₄)₂S₂O₈ (Wako Pure Chemical Industries Ltd., Cat No. 016-20501) were added to the suspension. The mixture was stirred at room temperature overnight, and then the mixture was centrifuged at 6000 rpm for 10 minutes to form a product, and the product (S-PEDOT nanospheres) was recovered.

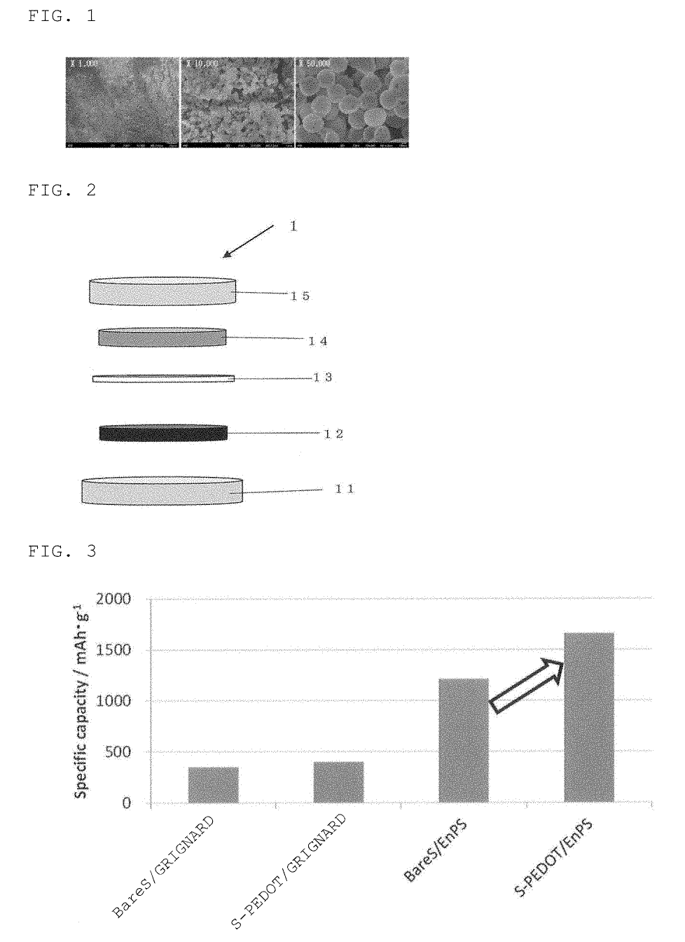

FIG. 1 shows SEM images (×1,000, ×10,000, ×50,000) of synthesized S-PEDOT nanospheres. As shown in FIG. 1, it was confirmed that spherical particles having a uniform size of about 300 μm in diameter were formed.

2. Production of Pellet Positive Electrode

A predetermined amount of S-PEDOT nano spheres, ketjen black, and polytetrafluoroethylene (PTFE) were mixed in an agate mortar. Next, while the resulting mixture was plunged in acetone, the mixture was rolled and molded about 10 times with a roller compactor. Thereafter, the molded product was dried for 12 hours under vacuum at 70° C. and a positive electrode was produced using sulfur particles (S-PEDOT nanospheres) coated with a poly(ethylenedioxy)thiophene conductive polymer obtained by doping PEDOT with camphorsulfonic acid. The content of S-PEDOT nanospheres was 10 mass % with respect to the total mass of the positive electrode.

### Comparative Example 1

1. Production of Pellet Positive Electrode

A predetermined amount of untreated sulfur (Bare S), ketjen black, and polytetrafluoroethylene (PTFE) were mixed in an agate mortar. Next, while the resulting mixture was plunged in acetone, the mixture was rolled and molded about 10 times with a roller compactor. After that, the molded product was dried under vacuum drying at 70° C. for 12 hours, and a positive electrode was produced using untreated sulfur (Bare S). The content of untreated sulfur (Bare S) was 10 mass % with respect to the total mass of the positive electrode.

According to Example 2 and Comparative Example 2 below, a positive electrode was produced by drop casting a sulfur carbon composite coated with a poly(ethylenedioxy)thiophene conductive polymer (PEDOT-PSS) obtained by doping PEDOT with polystyrene sulfonic acid, and a positive electrode was produced by directly drop casting a sulfur carbon composite. Then, coin battery cells were produced using the drop-casted positive electrodes produced in Example 2 and Comparative Example 2, and battery characteristics were evaluated.

### Example 2

1. Production of Drop-Casted Positive Electrode

Sulfur (S) and Ketjen black (KB) were mixed at a mass ratio (weight ratio) of 1:4 to prepare a sulfur carbon composite (S-KB composite). PEDOT-PSS (Clevios PH1000) was temporarily filtered with a PVdF filter (pore size: 0.45 μm) and subjected to ultrasonic treatment for 5 minutes with a homogenizer. 150 μL of PEDOT-PSS, 6 μL of dimethylsulfoxide, 1400 μL of H2O, and 500 μL of ethanol were added to 20 mg of the sulfur carbon composite (S-KB complex). The prepared sulfur carbon composite mixture was subjected to ultrasonic treatment for 15 minutes with the homogenizer. The sulfur carbon composite mixture after ultrasonic treatment was drop-casted on a metal foil, dried under vacuum at 60° C. for 12 hours, and dried under atmospheric pressure at 80° C. for 30 minutes, thereby producing a positive electrode with the drop-casted sulfur carbon composite coated with a poly(ethylenedioxy)thiophene conductive polymer (PEDOT-PSS) obtained by doping PEDOT with polystyrene sulfonic acid. The content of sulfur was 18 mass % with respect to the total mass of the positive electrode.

### Comparative Example 2

1. Production of Drop-Casted Positive Electrode

Regarding an untreated positive electrode obtained by directly drop casting a sulfur carbon composite without using PEDOT-PSS as a control, the same amount (150 μL) of H₂O was added in place of the PEDOT-PSS solution in preparing the sulfur carbon composite mixture, and the sulfur carbon composite was directly drop-casted. The content of sulfur was 18 mass % with respect to the total mass of the positive electrode.

Four coin battery cells were produced using the four positive electrodes produced in Examples 1 and 2 and Comparative Examples 1 and 2, respectively. The structure of the coin battery cell is shown in FIG. 2. As shown in FIG. 2, each of the four coin battery cells was produced by stacking a cathode can (made of SUS) 11, a positive electrode 12, a glass filter separator 13, a negative electrode 14, and an anode can (made of SUS) 15 in this order. As the positive electrode 12, each of the positive electrodes (pellet electrodes) produced in Example 1 and Comparative Example 1 and the positive electrodes (drop-casted electrodes) produced in Example 2 and Comparative Example 2 was used. As the negative electrode 14, an Mg plate (φ=1.5 mm, thickness: 250 μm) was used. The electrolytic solutions were two types, 1 M MgCl₂/ethyl n-propyl sulfone (hereinafter, sometimes referred to as “EnPS electrolytic solution”) and 0.25 M Mg(AlCl₂Et₂)₂/tetrahydrofuran (hereinafter, sometimes referred to as “Grignard-based electrolytic solution”).

In the case of the pellet positive electrodes produced in Example 1 and Comparative Example 1, the discharge conditions were set to 0.1 mA/0.7 V cut-off, and in the case of the drop-casted positive electrodes produced in Example 2 and Comparative Example 2, the discharge conditions were set to 0.05 mA/0.7 V cut-off. Further, in the case of the pellet positive electrodes produced in Example 1 and Comparative Example 1, the charge conditions were set to 0.1 mA/2.5 V cut-off, and in the case of the drop-casted positive electrodes produced in Example 2 and Comparative Example 2, the charge conditions were set to 0.05 mA/2.5 V cut-off.

Pellet positive electrode: results of electrochemical characteristics of magnesium-ion batteries (Mg—S batteries) when using S-PEDOT nanospheres and untreated sulfur (Bare S) as positive electrode active materials

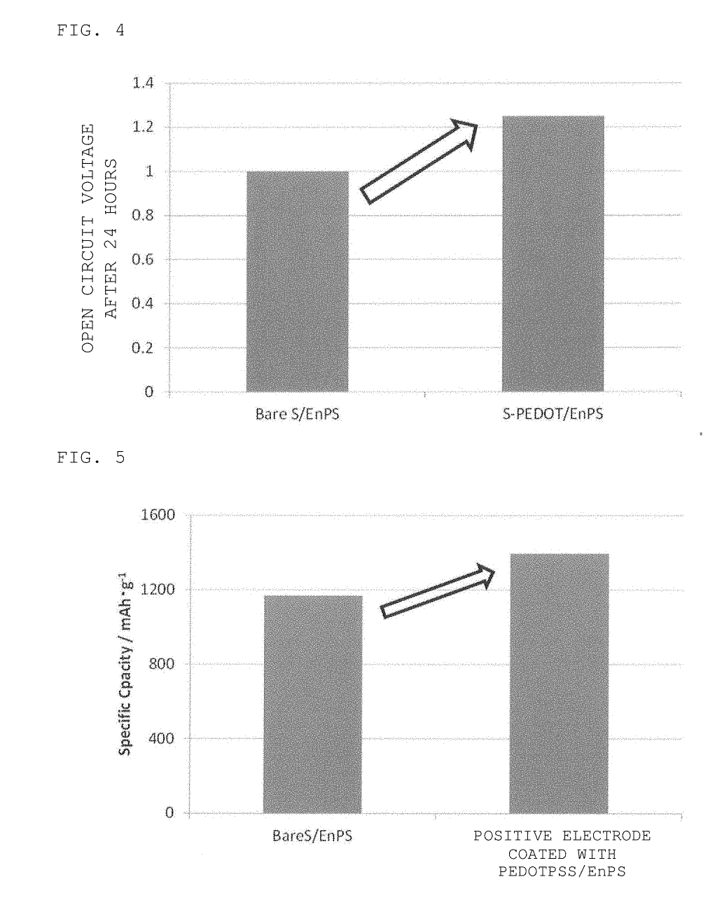

FIG. 3 shows the comparison results between the initial discharge capacity of an Mg—S battery using a pellet positive electrode formed by using S-PEDOT nanospheres produced in Example 1 as positive electrode active materials and using an EnPS electrolytic solution or Grignard-based electrolytic solution as an electrolytic solution, and the initial discharge capacity of an Mg—S battery using a pellet positive electrode formed by using untreated sulfur (Bare S) produced in Comparative Example 1 as a positive electrode active material and using an EnPS electrolytic solution or Grignard-based electrolytic solution as an electrolytic solution.

It was found that when EnPS was used as the electrolytic solution, the capacity of untreated sulfur (Bare S) was 1200 mAh/g, whereas the capacity of S-PEDOT nano sphere was 1600 mAh/g, and the coating of sulfur particles with the polyethylene dioxythiophene-based conductive polymer increased the reaction efficiency of sulfur. In the case of the Grignard-based electrolytic solution generally used for Mg batteries, the reaction capacities remained at about 300 mAh/g in both cases (untreated sulfur (Bare S)/Grignard-based electrolytic solution, and SPEDOT/Grignard-based electrolytic solution). Hence, in order to react sulfur with high efficiency, it is important to coat the sulfur with the polyethylene dioxythiophene-based conductive polymer. Further, in order to react sulfur with higher efficiency, it may be important which electrolytic solution is selected, and it may be important to use an electrolytic solution which contains a solvent containing sulfone.

It should be understood that the Mg—S cell formed by using S-PEDOT nanospheres maintained a high discharge capacity as compared with the Mg—S cell formed by using untreated sulfur (Bare S) all the time during cycle, and thus this showed the advantage of being coated with the polyethylene dioxythiophene-based conductive polymer. Furthermore, in the case of the Grignard-based electrolytic solution, it was found that the potential did not rise during charging in both cases of S-PEDOT and untreated sulfur (Bare S) and the cells were hardly discharged after the second cycle.

FIG. 4 shows the comparison results between the open circuit voltage after 24 hours in an Mg—S battery using a pellet positive electrode formed by using S-PEDOT nanospheres produced in Example 1 as positive electrode active materials and using an EnPS electrolytic solution as an electrolytic solution and the open circuit voltage after 24 hours in an Mg—S battery using a pellet positive electrode formed by using untreated sulfur (Bare S) produced in Comparative Example 1 as a positive electrode active material and using an EnPS electrolytic solution as an electrolytic solution.

When S-PEDOT nanospheres were used, the voltage was maintained higher than when using the untreated sulfur (Bare S), it was judged that the coating of the polyethylene dioxythiophene-based conductive polymer suppressed the elution of sulfur into the electrolytic solution.

Drop-casted electrode: results of discharge characteristics of an Mg—S battery using a positive electrode formed by using a sulfur carbon composite coated with polyethylene dioxythiophene-based conductive polymer (PEDOT-PSS) and an Mg—S battery using a positive electrode formed by using a sulfur carbon composite (untreated sulfur)

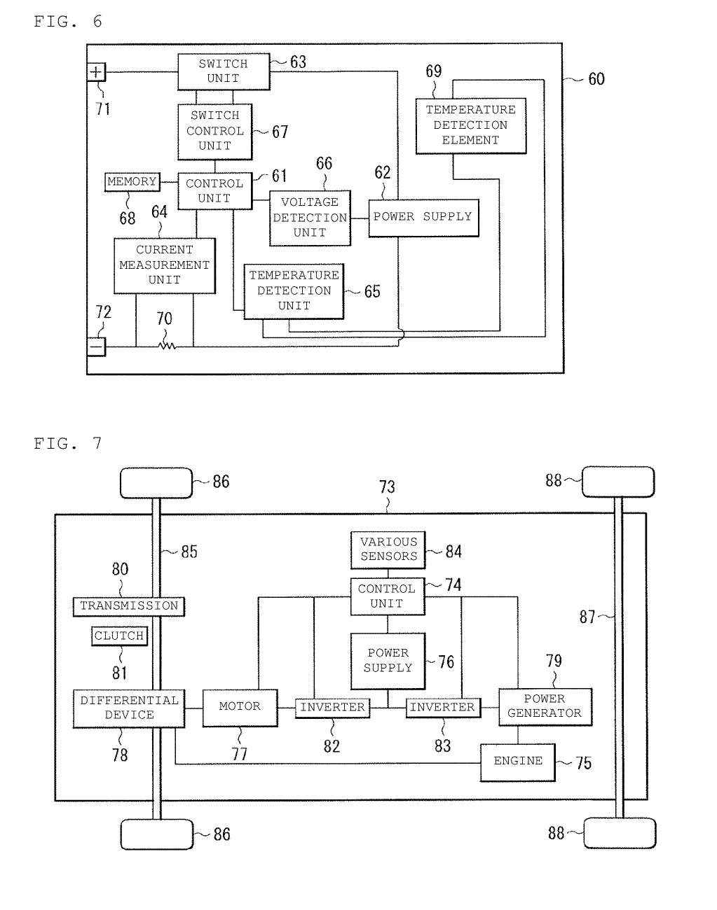

FIG. 5 is a diagram showing comparison results between the initial discharge capacity of an Mg—S battery using a positive electrode formed by coating the sulfur carbon composite produced in Example 2 with PEDOT-PSS and drop-casting the coated composite and using an EnPS electrolyte solution as an electrolytic solution and the initial discharge capacity of an Mg—S battery using a positive electrode (control) formed by drop-casting a sulfur carbon composite (untreated sulfur) and using an EnPS electrolyte solution as an electrolytic solution.

In the Mg—S battery using a positive electrode formed by using a sulfur carbon composite coated with PEDOT-PSS, the discharge capacity was increased as compared with the Mg—S battery using a positive electrode formed by using untreated sulfur (i.e., a sulfur carbon composite itself). This fact shows that, in order to realize a high efficient reaction of sulfur, it is advantageous to use the positive electrode formed by using a sulfur carbon composite coated with PEDOT-PSS, rather than the positive electrode formed by using untreated sulfur (i.e., a sulfur carbon composite itself). In the case of using the Grignard-based electrolytic solution, similarly to the result shown in FIG. 3, the discharge capacity remained low in both of the positive electrode formed by using a sulfur carbon composite coated with PEDOT-PSS and the positive electrode formed by using untreated sulfur (i.e., a sulfur carbon composite itself).

Regarding the cycle, in the Mg—S battery using a positive electrode formed by coating the sulfur carbon composite with PEDOT-PSS and drop-casting the coated composite, a high discharge capacity was maintained all the time as compared with the Mg—S battery using a positive electrode formed by drop-casting a sulfur carbon composite (untreated sulfur), and this showed the advantage of being coated with PEDOT-PSS. Furthermore, in the case of using the Grignard-based electrolytic solution, it was found that the potential did not rise during charging in both of the positive electrode formed by using a sulfur carbon composite coated with PEDOT-PSS and the positive electrode formed by using untreated sulfur (i.e., a sulfur carbon composite itself), and the cells were hardly discharged after the second cycle.

It is found that when an Mg—S battery is driven using a positive electrode formed by using S-PEDOT nanospheres obtained by coating sulfur (S) particles with a polyethylene dioxythiophene-based conductive polymer obtained by doping poly(ethylenedioxy)thiophene (PEDOT) with camphorsulfonic acid (sulfonic acid-based compound) as an active material, a higher discharge capacity is exhibited as compared with an Mg—S battery using untreated sulfur which is not treated with a polyethylene dioxythiophene-based conductive polymer as an active material. Further, it is found that an Mg—S battery using a positive electrode formed by coating a sulfur carbon composite with PEDOT-PSS (polyethylene dioxythiophene-based conductive polymer obtained by doping poly(ethylenedioxy)thiophene with a polystyrene sulfonic acid) and drop-casting the coated composite exhibits a higher discharge capacity as compared with a positive electrode formed by directly drop-casting a sulfur carbon composite.

Further, the electrolytic solution is not an arbitrary electrolytic solution and not the Grignard-based electrolytic solution generally used for Mg batteries in the Examples, and it is proved that the use of the EnPS electrolytic solution is an important factor in deriving the reaction efficiency of sulfur.

Two factors are considered as reasons. Firstly, it is considered that since the polyethylene dioxythiophene-based conductive polymer (PEDOT) is a conductive polymer, the polymer contributes to improvement in electronic conductivity of sulfur (i.e., an insulator) and contributes to improvement in reactivity of sulfur. Secondly, it is considered that the elution of sulfur into the electrolytic solution is suppressed by using PEDOT based on the result of FIG. 5, which is considered to contribute to improvement of initial discharge amount.

The above effects were observed regardless of the kind of dopant of PEDOT (camphorsulfonic acid, polystyrene sulfonic acid (PSS), etc.) and the method of coating sulfur (formation of nanospheres, drop-casting etc.), and this indicated that the coating of sulfur with a conductive polymer material had the effect of improving the performance of the sulfur positive electrode in the multivalent-ion secondary battery typified by a magnesium-ion secondary battery (Mg battery).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode active material for multivalent-ion secondary battery comprising sulfur,
wherein the sulfur is coated with a polyethylene dioxythiophene-based conductive polymer doped with a sulfonic acid-based compound.

2. A positive electrode for multivalent-ion secondary battery comprising at least a positive electrode active material,
wherein the positive electrode active material includes sulfur, and
wherein the sulfur is coated with a polyethylene dioxythiophene-based conductive polymer doped with a sulfonic acid-based compound.

3. A multivalent-ion secondary battery comprising: the positive electrode for multivalent-ion secondary battery according to claim 2; a negative electrode; and an electrolytic solution,
wherein the electrolytic solution includes a solvent including sulfone and a metal salt dissolved in the solvent.

4. The multivalent-ion secondary battery according to claim 3, wherein the metal salt includes a magnesium salt.

5. A battery pack comprising: the multivalent-ion secondary battery according to claim 3; a controller configured to control a usage state of the multivalent-ion secondary battery; and a switch configured to switch the usage state of the multivalent-ion secondary battery in response to an instruction from the controller.

6. An electric vehicle comprising: the multivalent-ion secondary battery according to claim 3; a converter configured to convert electric power supplied from the multivalent-ion secondary battery to driving force; a driver configured to drive in response to the driving force; and a controller configured to control a usage state of the multivalent-ion secondary battery.

7. A power storage system comprising: the multivalent-ion secondary battery according to claim 3; one or more electric devices in which electric power is configured to be supplied from the multivalent-ion secondary battery; and a controller configured to control supply of power from the multivalent-ion secondary battery to the electric devices.

8. A power tool comprising: the multivalent-ion secondary battery according to claim 3; and a movable part to which electric power is configured to be supplied from the multivalent-ion secondary battery.

9. An electronic device comprising the multivalent-ion secondary battery according to claim 3 as a power supply source.

10. A positive electrode for multivalent-ion secondary battery comprising at least a sulfur carbon composite including sulfur and a carbon material,
wherein the sulfur carbon composite is coated with a polyethylene dioxythiophene-based conductive polymer doped with a sulfonic acid-based compound.

11. A multivalent-ion secondary battery comprising: the positive electrode for multivalent-ion secondary battery according to claim 10; a negative electrode; and an electrolytic solution, wherein the electrolytic solution includes a solvent containing sulfone and a metal salt dissolved in the solvent.

12. The multivalent-ion secondary battery according to claim 11, wherein the metal salt includes a magnesium salt.

13. A battery pack comprising: the multivalent-ion secondary battery according to claim 11; a controller configured to control a usage state of the multivalent-ion secondary battery; and a switch configured to switch the usage state of the multivalent-ion secondary battery in response to an instruction from the controller.

14. An electric vehicle comprising: the multivalent-ion secondary battery according to claim 11; a converter configured to convert electric power supplied from the multivalent-ion secondary battery to driving force; a driver configured to drive in response to the driving force; and a controller configured to control a usage state of the multivalent-ion secondary battery.

15. A power storage system comprising: the multivalent-ion secondary battery according to claim 11; one or more electric devices in which electric power is configured to be supplied from the multivalent-ion secondary battery; and a controller configured to control supply of power from the multivalent-ion secondary battery to the electric devices.

16. A power tool comprising: the multivalent-ion secondary battery according to claim 11; and a movable part to which electric power is configured to be supplied from the multivalent-ion secondary battery.

17. An electronic device comprising the multivalent-ion secondary battery according to claim 11 as a power supply source.
